(19) United States
(12) Patent Application Publication
(10) Pub. No.: US 2017/0337725 A1
(43) Pub. Date: Nov. 23, 2017

(54) Methods for Maintaining Image Integrity of Images Wrapped Around a Three Dimensional Object

(71) Applicant: Katewinka, LLC, Indianapolis, IN (US)

(72) Inventors: Kimberly Carol White, Plainfield, IN (US); Douglas Perianu Knoll, Indianapolis, IN (US); Deborah Rae Beck, Zionsville, IN (US); Katelyn Campbell Schmidt, Terre Haute, IN (US)

(21) Appl. No.: 15/492,283

(22) Filed: Apr. 20, 2017

Related U.S. Application Data
(60) Provisional application No. 62/325,216, filed on Apr. 20, 2016.

(51) Int. Cl. G06T 15/04; G06T 15/00

(52) U.S. Cl. CPC G06T 15/04; G06T 15/005

(57) ABSTRACT

A method is provided that uses commercially available drawing software to manipulate two dimensional images to match all horizontal objects in the image to be wrapped around a tapered or frusto-conical cup. The method allows a novice user with no graphic design experience to create a satisfactory image that avoids the unrealistic “tenting” distortion effect caused by the taper of the cup. The method includes altering the image and transforming it so that the horizontal elements maintain their integrity despite the geometry of the cup. With this method, all horizontal objects within the design appear in the cup as horizontal, even though the image has been manipulated to be non-horizontal in a two dimensional version of the image. In one aspect, the image can be personalized with color by the user. In some embodiments, such as with the use of transparency film, the art work can create a stained glass or painted stainless steel effect.

### PRIORITY CLAIM

This application is a utility filing from and claims priority to co-pending provisional application No. 62/325,216, which was filed on Apr. 20, 2016, the entire disclosure of which is incorporated herein by reference.

### BACKGROUND

Travel mugs have become very popular as staying hydrated or enjoying coffee and other beverages while on the move has become a cultural phenomenon. Other cultural phenomena are the demand for personalization and “do it yourself” projects. Some companies, such as Niel Enterprises, market travel mugs that allow the purchaser to customize the cup with a favorite photograph or other image. The cups have an inner member for containing a beverage, an outer transparent layer and a removable top or bottom that allows access to the space between the inner member and outer layer. The outer layer is often a transparent material, such as an acrylic, which provides a window for viewing a personalized image inserted within the space, such as the lake scene in FIG. 1. However, because the cups are tapered it has been impossible to obtain a pleasing 360° image around the cup. Elements of the image will not match at the junction when the image is wrapped around the tapered cup because, while the image is two dimensional, the cup is tapered.

To avoid this problem, the cups have been provided that incorporate a set of frames F in which a photograph P can be placed, as shown in FIG. 2. The frames and the designs on the frame hide the issue to some extent but the user is limited to the frames provided by the manufacturer. The images on the frames tend to be images that do not have an obvious horizontal reference so that it is not noticeable that the two dimensional image has been placed on a tapered item. The user is also unable to enjoy the image in the full window of the cup and the frame images typically do not match at the seam S, as shown in FIG. 3. A further disadvantage is that taping a photograph to the frame makes the resulting insert bulky which is difficult to insert and position within the cup.

Another approach is an online template such as the one provided at www.InstantPhotoGift.com. The photograph shown in FIG. 1 has been modified using such an online template to form the curved print P′ shown in FIG. 4. While this is a step forward in personalizing beverage-ware, the resulting image forms an unrealistic tenting effect at the seam when the print is wrapped into a cone, as shown in FIG. 5. None of these options allow the user to use a large photograph without a frame or without visual distortion of the image when used in the tapered cup.

Another cultural phenomenon is the adult coloring book. Adult coloring books, or coloring books with a high amount of detail, have become very popular as people have recognized the relaxing effect of coloring complex designs. It has even been suggested that adult coloring has a therapeutic health benefit as discussed in: http://www.cnn.com/2016/01/06/health/adult-coloring-books-popularity-mental-health/; and http://www.medicaldaily.com/therapeutic-science-adult-coloring-books-how-childhood-pastime-helps-adults-356280; and http://www.huffingtonpost.com/dr-nikki-martinez-psyd-lcpc/7-reasons-adult-coloring-books-are-great-for-your-mental-emotional-and-intellectual-health_b_8626136.html.

The finished product is often quite beautiful and viewing it evokes pleasant, calming feelings that further the therapeutic effect. The coloring books also allow the user to personalize the art work by selecting the colors, but as an adult there is no practical manner of showing off one's art work without embarrassment.

### SUMMARY OF THE DISCLOSURE

The present invention provides a solution to the problems of prior approaches to integrating planar artwork into a tapered or conical cup or container. In particular, the present invention contemplates a method that can be implemented using commercially available software, such as Adobe Photoshop or another similar software system, which allows a user to manipulate two dimensional images to match all horizontal objects in an image for placement within a tapered cup. The inventive method allows a novice user with no graphic design experience to create a satisfactory image for placement within a tapered cup or similar object. The satisfactory image avoids the aforementioned unrealistic “tenting” distortion effect caused by the taper of the cup, by altering the image and transforming it so that the horizontal elements keep their integrity despite the geometry of the cup. With this method, all horizontal objects within the design appear in the cup as horizontal, even though the image has been manipulated to be non-horizontal in a two dimensional version of the image. The invention also provides a cup and a design that can be personalized with color by the user. In some embodiments, such as with the use of transparency film, the art work can create a stained glass or painted stainless effect.

### DESCRIPTION OF THE FIGURES

FIG. 1 is a plan view of an image to be transformed according to the present method.

FIG. 2 is a plan view of the image of FIG. 1 incorporated into frames according to a prior art technique.

FIG. 3 is a side view of a cup with the image and frame of FIG. 2 wrapped around the cup.

FIG. 4 is a curved print of the image of FIG. 1 according to another prior art technique.

FIG. 5 is a side view of the curved print of FIG. 4 wrapped around a cup.

FIG. 6 is a diagram of a template layer used in a first step of the present method.

FIG. 7 is a diagram of the image of FIG. 1 provided as a second layer that is overlaid on the template layer shown in FIG. 6.

FIG. 8 is a diagram of a further step of the present method in which the upper corners of the template and image layers are aligned.

FIG. 9 is a diagram of the layers shown in FIG. 8, with the image layer further manipulated to align the perimeter edges of the image layer with the perimeter edges of the template layer.

FIG. 10 is a diagram depicting a further step of the method in which the image layer is divided into a number of rows and columns of shapes.

FIG. 11 is a plan view of the image of FIG. 1 transformed using the present method.

FIG. 12 is a plan view of the transformed image of FIG. 11 showing registration points for adjusting the image transformation according to one aspect of the present method.

FIG. 13 is a further transformation of the image of FIG. 11 for alignment of the registration points shown in FIG. 12.

FIG. 14 is a side view of the transformed image shown in FIG. 13 wrapped around a cup.

FIG. 15 are side views of two cups with images generated according to the present method and according to the prior art.

FIG. 16 is a perspective view of a colorable image insert for insertion into a frusto-conical cup.

FIG. 17 is a side view of the colorable image shown in FIG. 16 wrapped around a cup.

FIG. 18 is a perspective view of the colorable image of FIG. 16 adapted to provide a stained glass effect.

FIG. 19 is a perspective view of the colorable image of FIG. 16 adapted to provide a stainless steel effect.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

One embodiment provides a method for manipulating an image for placement within a tapered object so that all horizontal objects match at the seam of the image. For illustrative purposes, the method steps described herein are executed using Adobe Photoshop, but it is understood that similar steps can be implemented in other software systems. The following description of the method assumes two “layers” in Adobe Photoshop—one layer containing a template (unchanging), and a second layer containing the image (changing). In one embodiment, the inventive method comprises the following steps:

1. Create a template (Layer 1) for a particular three-dimensional object, in which the template corresponds to a two-dimensional projection of the outer surface of the three-dimensional object. In the illustrated embodiment, the template (Layer 1) corresponds to the two-dimensional projection of the outer surface of a frusto-conical cup (such as the cup shown in FIG. 3), with the template appearing as shown in FIG. 6.
2. Overlaying the image (Layer 2) over the template (Layer 1) and manipulating the image (Layer 2) while maintaining image proportions using known techniques so that both the lower corners 10, 11 of the image are aligned with the respective lower corners of the template (Layer 1), as illustrated in FIG. 7.
3. Further manipulating the image so that the upper corners 15, 16 of the image (Layer 2) and the template (Layer 1) are aligned, as depicted in FIG. 8.
4. Manipulating the image (Layer 2) so that the dimensions of the image layer are changed as shown in FIG. 9, namely so that the perimeter edges of the image layer 2 match the perimeter edges of the template layer 1. To accomplish this manipulation, the present method contemplates dividing the image (Layer 2) into a number of rows aᵢ, bᵢ, cᵢ. Each row comprises identical shapes, e.g. a₁, a₂, and a₃, as geometrically represented in FIG. 10. The geometry of these shapes are changed based on the template (Layer 1), or on the type of cup or container used. Each row is defined between the upper and lower edges by at least two parallel, curved line segments 27, 28, which are transposed from concentric circles and which are interiorly equidistant and share the same origin 23. The line segments 27, 28 are also equidistant with the upper and lower edges of the image (Layer 2). Each row is divided into the identical shapes by successive line segments 20, 21, 24, 25, all extending radially from the common origin 23. In one embodiment shown in FIG. 10, the number of rows is three and each row is composed of three identical shapes, such as shapes a1, a2 and a3 in FIG. 10. The geometry of each shape is manipulated to align the perimeter edges of the image (Layer 2) with the perimeter edges of the template (Layer 1) as depicted in FIG. 9, so that the final image (Layer 2) appears as shown in FIG. 11. As shown in FIG. 9, the curved line segments 27, 28 maintain their equidistant relationship even as the upper edge of the image (Layer 2) is moved upward to match the upper edge of the template (Layer 1), and as the lower edge of the image is moved downward to match the lower edge of the template. The line segments 20, 21, 24, 25 maintain their generally radial orientation emanating from the origin 23 but can be at least initially warped as the upper and lower corners are aligned, as shown in FIG. 8. However, once the left and right side edges of the image (Layer 2) are moved outward to match the left and right side edges of the template (Layer 1) the line segments assume their linear configuration radiating from the common origin 23.
5. In the next step, it is confirmed that all horizontally continuous shapes, such as shapes a1, a2 and a3, meet when the image is wrapped around the truncated cone. For instance, in the present example of a lakeshore view, the horizon presents a horizontally continuous element that must be matched at the overlapping edges of the image. See, FIG. 12. If they do not all match, such as in the case of a parallax effect in the original photography, the transformation points of the individual rows (along lines 21, 22, 24, 25) can be manually adjusted to alleviate the incongruence while maintaining the radial relationship of these line segments. It can be appreciated that with the commercially available software, such as Adobe Photoshop, this manipulation can occur as a drag-and-drop action.
6. Printing the final manipulated or transformed image on a medium suitable to be wrapped around the outer surface of the three-dimensional object, such as a frusto-conical cup.

Although the manual adjustment achieves a more pleasing image than with no adjustment, this can be tedious and frustrating even for skilled graphic designers. Thus, the present invention contemplates another embodiment in which a computer program automatically transforms the image to conform to the projected geometry of FIG. 10, reaching a final image similar to FIG. 11. The method of this alternative embodiment comprises the steps of:

1. Opening the software program or bringing up a website containing the program.
2. The program prompts the user to select an image file on the user's computer that is desired to be transformed.
3. The image file is then transformed so that each corner of the image, and the subsequent image data contained between, are projected from the original image in a similar fashion as depicted in FIG. 10, resulting in a final image similar to FIG. 11.
4. The transformed image file is then further transformed such that for every point in the original image, there exists a relative point on the template defined by the geometric projection described in relation to FIG. 10. The algorithm determines these points and adjusts the image data so that every relative point is registered in the final file.
5. The user can then confirm this transformed image, and print a test page to be tested around the truncated cone shaped cup.
6. Should some horizontally continuous elements not match, such as a horizon distorted by a parallax effect in the photography, or a drawing or other art piece in which horizontal elements intended to line up do not, the user can then select an option to further adjust the image by adding their own manual register points to further conform the image to their visual standards, as depicted in FIG. 12. These manual registration points are assigned at the straight edges of the transformed template, and are then used by the program to override the automatically assigned points, smoothly adjusting the image further. This will allow the user to create a 360° contiguous image, even when the source image contains unintended horizontally untileable elements. The user is provided with an exported image file in a known format, such as JPG, which could then be printed or stored for printing at another location.

In yet another embodiment, a software program can employ an image recognition algorithm to automate the process of transforming the image for the elimination of unintended horizontally untileable elements. The method of this embodiment comprises the following steps:

1. Opening the software program or bringing up a website containing the program.
2. The program prompts the user to select an image file on the user's computer that is desired to be transformed.
3. This file is then transformed in the following such that for every point in the original image (Layer 2), there exists a relative point on the template (Layer 1) defined by the geometric projection depicted in FIG. 10. The software program executes an algorithm to determine these points and adjust the image data so that every relative point is registered in the final file. Then, the additional image recognition algorithm scans the two straight edges and determines elements that are still incongruous with their counterpart. The algorithm then automatically defines additional registration points to override the original transformation, smoothly adjusting the image further.
4. The user is provided with an exported image file in a known format, such as JPG, which could then be printed or stored for printing at another location.

In yet another embodiment, the previous two embodiments are merged, leaving the option for additional image recognition techniques to be automatically operated by the computer software before manual registration points are added by the user.

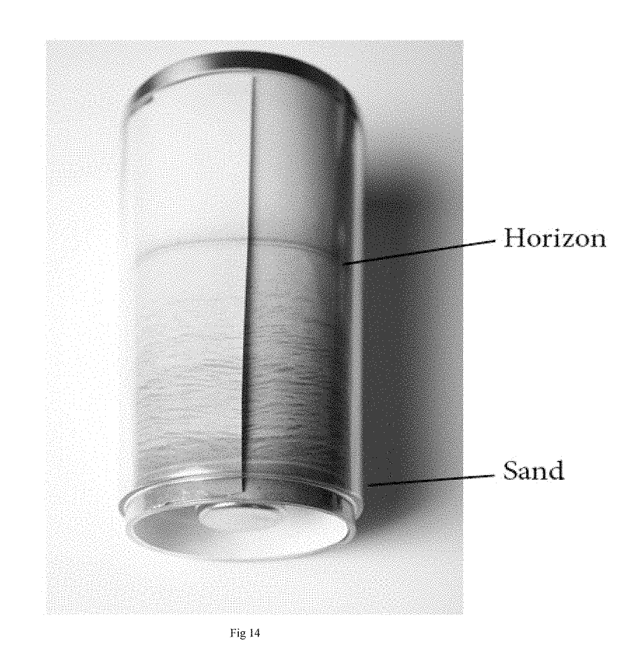

In yet another embodiment, the software provides one or more preview windows, showing the user how the junction will appear when applied to a particular three dimensional object or shape. FIG. 12 shows two preview windows near the left and right edges of the image (Layer 2). The preview windows provide the user with the ability to, before printing, predict and adjust the manual registration points as necessary to achieve the aligned elements as shown in the image of FIG. 13. Once applied to the three dimensional object, the elements align at the junction. In FIG. 14, both the sand and the horizon are aligned when the image is wrapped around a frusto-conical cup.

In some embodiments the junction will include one opposing edge overlapping the another. In the software, this overlap area is represented with a dark rectangle at some opacity over the affected portion, as shown in FIG. 12. The opacity can be 50% so that the underlying image can be partially viewed. In other embodiments the edges will be flush and the opacity feature is not required.

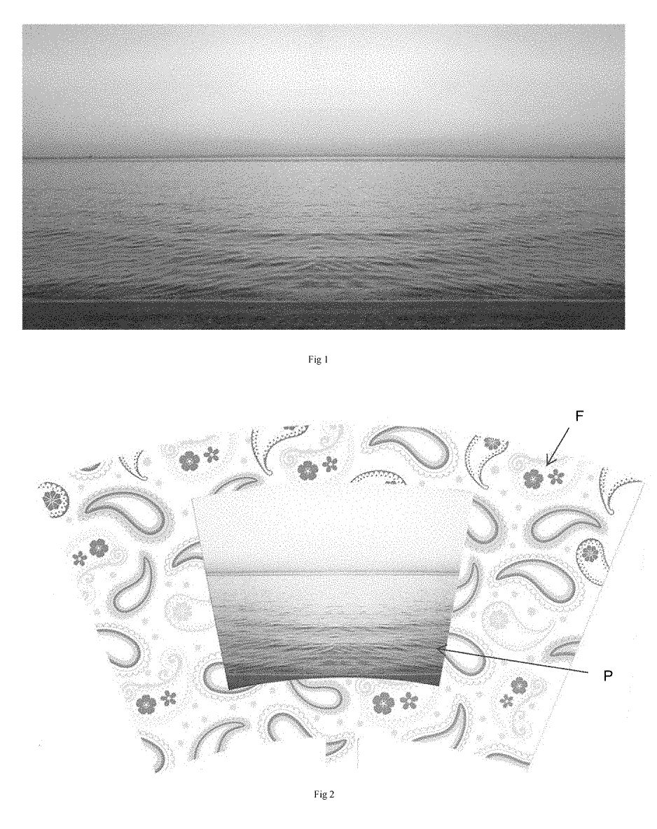

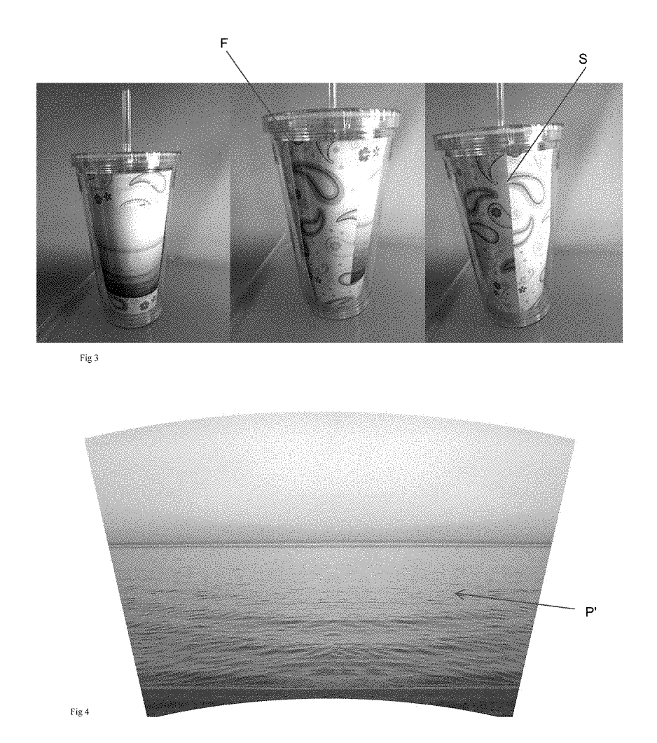

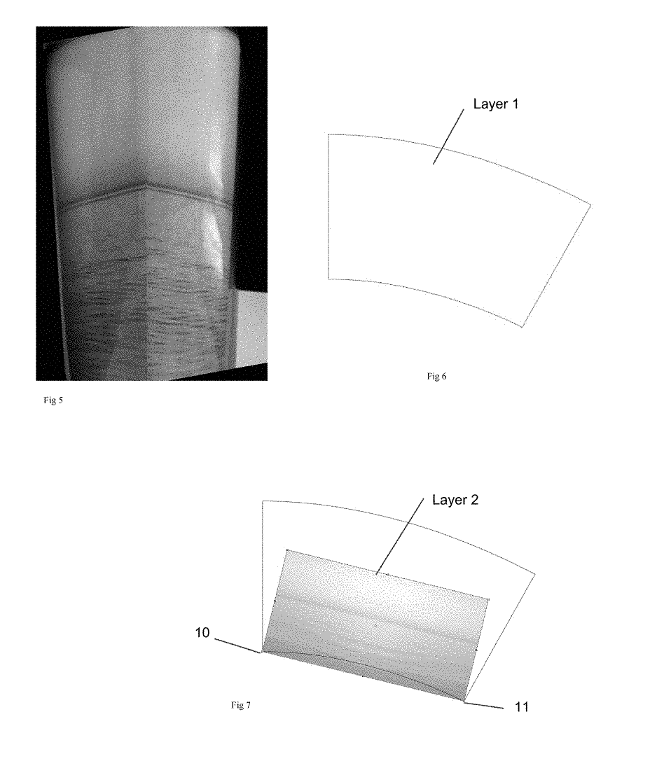

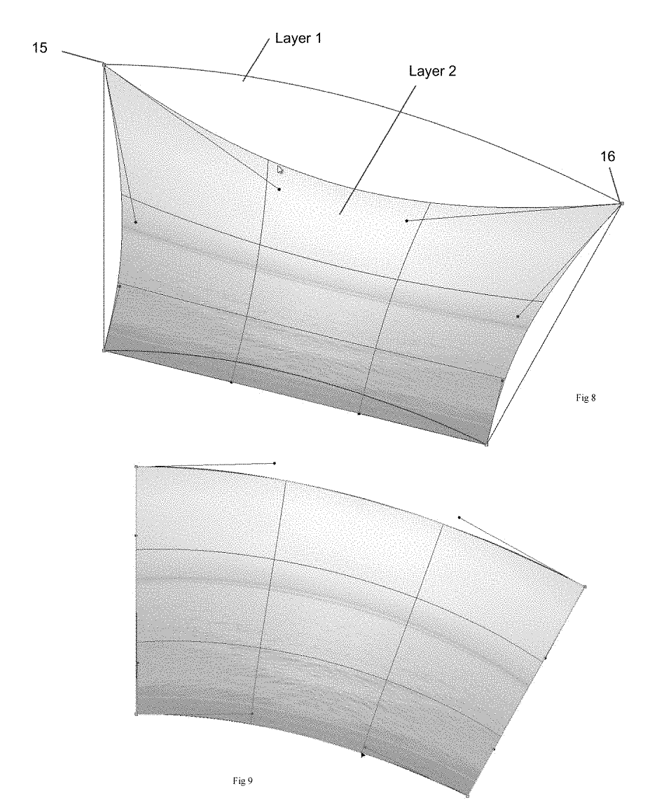

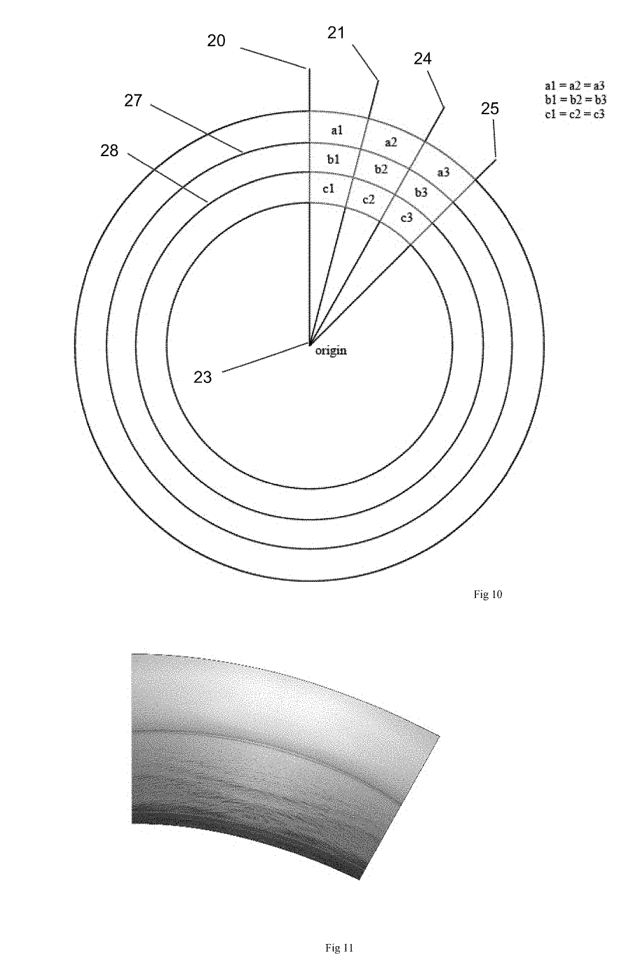

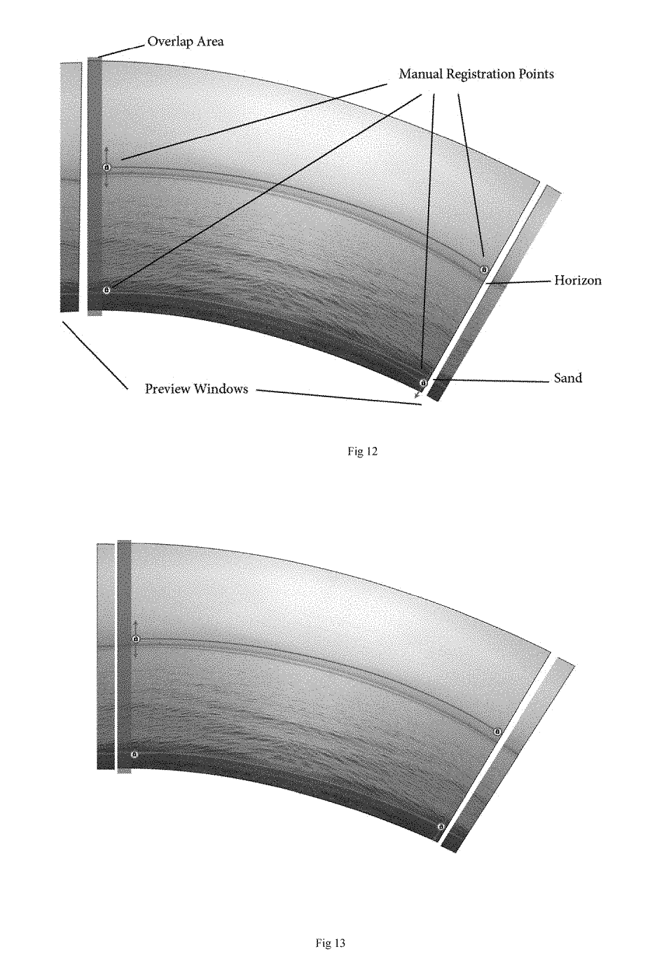

In some images, even aligning the elements is not enough to create a visually pleasing result, due to differences inherent in the appearance on the sides of the original image. For example, in an image such as FIG. 1, certain elements such as the sand, water, or sky can appear to have different attributes such as color, texture, or density on the left and right sides. While these differences may create visual interest in the original two-dimensional image, they may not create a pleasing result at the junction in a three-dimensional application. In yet another embodiment, the software provides the option to blur or soften a portion or portions of the image so that elements are more compatible in the three dimensional application, and are less visually distracting at the junction, creating a more visually pleasing 360° image.

In yet another embodiment, the software provides an option to create a mirror image from a portion of the image to avoid differences in the appearance of attributes on the left or right side of the original image. The mirror image option creates an even more uniform appearance at the junction.

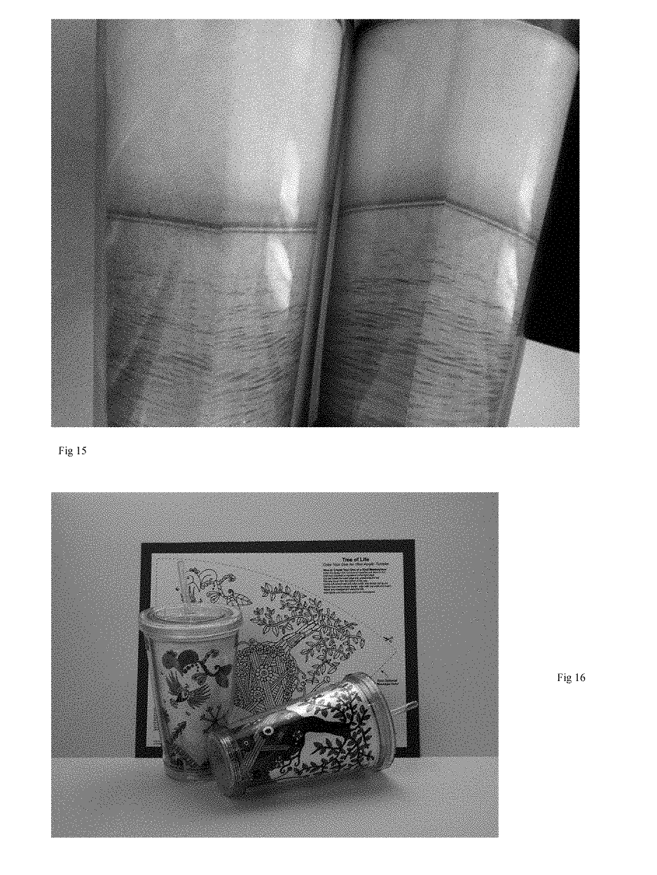

FIG. 15 shows a cup on the left of the figure that was made according to the steps of the present invention and a cup on the right of the figure that was made with the prior art template. The cup on the left has a realistic matching at the junction while the image on the right matches with a tenting effect caused by the prior art template.

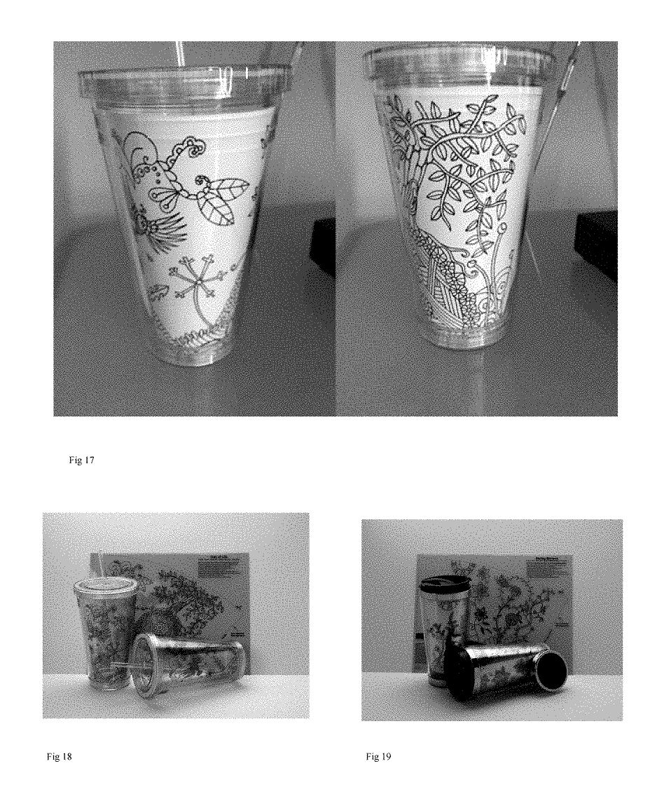

In another embodiment, a color-your-own cup set is provided which includes a cup with an inner member and an outer acrylic or other transparent layer that forms a window to display an image inserted between the inner member and the outer window. The cup set also includes a design that is suitable for coloring and that is insertable between the inner member and the window for viewing, preferably after coloring as shown in FIG. 16. The design is created or manipulated for the shape of the particular cup, such that the design appears to be level on all sides of the cup as shown in FIGS. 16 and 17. In one aspect, the design can be treated like an image that is manipulated according to the methods described above. The design is printed on a medium that can be colored on by the user. In yet another embodiment, the medium is a transparency film so the design once colored and inserted creates a stained glass effect, as shown in FIG. 18, or a painted stainless steel effect, as shown in FIG. 19.

The present disclosure should be considered as illustrative and not restrictive in character. It is understood that only certain embodiments have been presented and that all changes, modifications and further applications that come within the spirit of the disclosure are desired to be protected.

What is claimed is:

1. A methods for transforming a two-dimensional image to be wrapped around a three dimensional object, comprising:
creating a template layer corresponding to the projected two-dimensional shape of the outer surface of the three-dimensional object about which the transformed two-dimensional image is to be wrapped;
overlaying the image as an image layer over the template layer;
manipulating the image layer so that the lower corners of the image layer are aligned with the lower corners of the template layer, while maintaining the image proportions of the image in the image layer;
manipulating the image layer so that the upper corners of the image layer are aligned with the upper corners of the template layer, while maintaining the image proportions of the image in the image layer;
generating a plurality of rows in the image layer, with each row including a plurality of identical shapes, the plurality of rows defined by at least two parallel curved line segments of concentric circles having a common origin, the line segments being mutually equidistant and equidistant relative to the upper and lower edges of the image layer;
manipulating the perimeter edges of the image layer to align with the perimeter edges of the template layer while maintaining the identity of the identical shapes and the equidistant relationships of the line segments; and
printing the resulting image layer on a medium to be wrapped around the three-dimensional object.

2. The method of claim 1, wherein the object is a frusto-conical cup.

3. The method of claim 1, wherein the medium is a medium that can be colored by a user.

4. The method of claim 1, wherein the medium is a transparent film.

5. The method of claim 1, wherein the step of manipulating the perimeter edges includes:
wrapping the image layer to the shape of the outer surface of the three-dimensional object with the opposite side edges overlapping;
determining whether any horizontally continuous elements of the image align at the overlapping edges; and
if not then manipulating the identical shapes in at least one row until the horizontally continuous elements of the image align at the overlapping edges.
